(19) United States
(12) Patent Application Publication
(10) Pub. No.: US 2022/0325145 A1
(43) Pub. Date: Oct. 13, 2022

(54) POLYOLEFIN-CONTAINING HOT-METAL ADHESIVES

(71) Applicant: Bostik, Inc., Wauwatosa, WI (US)

(72) Inventors: Brian R. Minix, Wauwatosa, WI (US); Steven D. Gray, Wauwatosa, WI (US); Miao Hu, Wauwatosa, WI (US); Kimberly E. Secrist, Wauwatosa, WI (US)

(21) Appl. No.: 17/641,470

(22) PCT Filed: Jul. 30, 2020
(86) PCT No.: PCT/US2020/044163

§ 371 Date: Mar. 9, 2022

Related U.S. Application Data
(60) Provisional application No. 62/881,462, filed on Aug. 1, 2019.

(51) Int. Cl. C09J 123/12; C09J 7/35; C09J 7/24

(52) U.S. Cl. CPC C09J 123/12; C09J 7/35; C09J 7/243

(57) ABSTRACT

A hot melt adhesive uses a blend of polymers having controlled stereoerror and comprises a stereoblock polypropylene comprising a first block having an isotactic index of between about 50% and about 95% and a second block having an isotactic index of between about 5% and 50%, wherein the difference between the isotactic indeces of the first block and the second block is at least about 10%. The hot melt adhesive exhibits improved peel and tack properties without compromising shear strength and vice versa.

### CROSS-REFERENCE TO RELATED APPLICATIONS

This application claims priority under 35 U.S.C. § 119(e) to U.S. Patent Application No. 62/881,462 filed Aug. 1, 2019.

### FIELD OF THE INVENTION

This invention relates to a hot melt adhesive compositions based on stereoblock polypropylene polymers where two or more discrete segments of the polymer backbone possess differing isotactic index values that influence the ultimate thermomechanical properties.

### BACKGROUND OF THE INVENTION

Hot melt adhesives typically exist as a solid mass at ambient temperature and can be converted to a flowable liquid by the application of heat. These adhesives are useful in a wide variety of applications, such paper products, book bindings, packaging materials, automotive parts such as door panels, aerospace applications, appliances, tapes and labels, and hygiene articles, including those containing nonwoven substrates. Some hot melt adhesives are especially useful in manufacturing a variety of disposable goods where bonding of various substrates is often necessary. Specific applications include disposable diapers, hospital pads, feminine sanitary napkins, panty shields, surgical drapes and adult incontinent briefs, collectively known as disposable nonwoven hygienic products.

In most of these applications, the hot melt adhesive is heated to its molten state and then applied to a substrate, often named as the primary substrate. For preparation of a tape or label, often only a primary substrate is used. In other applications, a second substrate, often named as the secondary substrate, is then immediately brought into contact with and compressed against the first. The adhesive solidifies on cooling to form a strong bond. The major advantage of hot melt adhesives is the absence of a liquid carrier, as would be the case of water or solvent based adhesives, thereby eliminating the costly process associated with solvent removal.

For many applications, hot melt adhesives are often extruded directly onto a substrate in the form of a thin film or a bead by using piston or gear pump equipment. In this case, the substrate is brought into intimate contact with a hot die under pressure. The temperature of the die must be maintained well above the melting point of the adhesive to allow the molten hot melt material to flow through the application nozzle smoothly. For most applications, particularly those encountered in food packaging and disposable nonwovens hygienic article manufacturing, bonding of delicate and heat sensitive substrates, such as thin gauge plastic films, is often involved. This imposes an upper limit on the coating temperature for hot melt adhesive applications. In many applications, today's commercial hot melts are typically formulated to have coating temperature below 200° C., preferably below 150° C., to avoid substrate burning or distortion.

Besides directly coating, several indirect or noncontact coating methods, through which a hot melt adhesive can be spray coated with the aid of compressed air onto a substrate from a distance, are also developed. These non-contact coating techniques include conventional spiral spray, Omega™ Surewrap™ and various forms of melt-blown methods. The indirect method, however, requires that the viscosity of the adhesives must be sufficiently low, usually in the range of 2,000 to 30,000 mPa·s, preferably in the range of 2,000 to 15,000 mPa·s, at the application temperature in order to obtain an acceptable coating pattern. Many other physical factors, especially the rheological properties of the adhesive, come into play in determining the sprayability of a hot melt. The majority of commercial hot melt products do not lend themselves to spray applications. There are no accepted theoretical models or guidelines to predict sprayability, which must be determined empirically with application equipment.

Hot melt adhesives are organic materials typically consisting of a polymer, a plasticizer, a tackifying resin, and an antioxidant package. Other ingredients, such as waxes, fillers, colorants, and UV absorbers, can also be used to modify the adhesive properties or to provide special attributes. These organic ingredients are prone to heat degradation under the coating conditions of the adhesive. For example, a widely used commercial hot melt adhesive based on styrene-isoprene-styrene (SIS) triblock copolymer, when subjected to 175° C. for 24 hours, can suffer from a viscosity drop of about 50 percent from its original value. A styrene-butadiene-styrene (SBS) based hot melt may cause problems by crosslinking under similar conditions. Crosslinking can result in a dramatic increase in viscosity and may eventually render the adhesive un-flowable by the formation of a three dimensional polymer network. The viscosity change is often accompanied by charring, gelling, and formation of skin on top of the molten material. The degradation will inevitably lead to deterioration of the adhesive properties and performance. In addition, they can also cause equipment damage. The rate of degradation is temperature dependent; the higher the temperature, the faster the degradation. Thus, reducing the coating temperature of the adhesive can slow down degradation.

### SUMMARY OF THE INVENTION

It is desirable to develop hot melt adhesives with improved tack and shear properties, including when used to bond low energy substrates, such as polyethylene and polypropylene substrates, and are stable after aging. At relatively low viscosity values required for application of many hot melt adhesives, it is believed that one must often improve peel or tack (adhesion) at the expense of reduced shear strength (cohesion), or improve shear strength at the expense of peel or tack. It would be desirable to develop low-viscosity, readily-applied hot melt adhesives that display improved peel or tack without compromising shear strength and vice versa.

According to an embodiment of the invention, a hot melt adhesive composition comprises: (a) a stereoblock polypropylene comprising a first block having an isotactic index of between about 50% and about 95% and a second block having an isotactic index of between about 5% and 50%, wherein the difference between the isotactic index of the first block and the isotactic index of the second block is at least about 10% and (b) at least one of a tackifying resin or a plasticizer.

According to another embodiment of the invention, a method for making a laminate comprising the steps of: applying the hot melt adhesive composition of the invention in a molten state to a primary substrate; and, optionally, mating a secondary substrate to the first substrate by contacting the secondary substrate with the adhesive composition.

According to another embodiment of the invention, a hot melt adhesive composition comprises: (a) a stereoblock polypropylene comprising a first block having an isotactic index of between about 50% and about 95% and a second block having an isotactic index of between about 5% and 50%, wherein the difference between the isotactic index of the first block and the isotactic index of the second block is at least about 10% and (b) at least one of a tackifying resin or a plasticizer, wherein the stereoblock polypropylene and the at least one of the tackifying resin and the plasticizer are present in amounts effective to provide a hot melt adhesive composition which has: peel strength at 90° of at least 0.5 pound-force after aging at 25° C. when applied at 5 gsm add-on between a first polyethylene layer and a second polyethylene layer; (2) an initial loop tack of at least 1 pounds-force and an aged loop tack of at least 1 pounds-force when a polyethylene looped thread is applied to stainless steel at an adhesive thickness of 3 mils using an Instron 5500R tensile test frame equipped with a 100 Newton load cell with a speed of 12 inches per minute; and (3) a shear value of at least 500 minutes at 23° C. when applied between polished stainless steel and polyethylene terephthalate using a 1 kilogram weight.

Other features and advantages of the invention may be apparent to those skilled in the art upon reviewing the following drawings and description thereof.

### DETAILED DESCRIPTION OF THE INVENTION

According to an embodiment of the invention, a hot melt adhesive composition comprises: (a) a stereoblock polypropylene comprising a first block having an isotactic index of between about 50% and about 95% and a second block having an isotactic index of between about 5% and 50%, wherein the difference between the isotactic index of the first block and the isotactic index of the second block is at least about 10% and (b) at least one of a tackifying resin or a plasticizer.

As used herein, a stereoblock polypropylene means a propylene homopolymer that has at least two blocks of different tacticity. Tacticity is the measure of regularity of adjacent chiral centers in polymers with pendant side groups. Higher tacticity values indicate more chiral centers have the same type of orientation. The level of tacticity influences the crystallinity and, in turn, a variety of materials properties such as the melting point, tensile strength, solubility, and numerous others. For adjacent chiral centers (diads), there are two possible orientations: meso (m) where the two centers have the same orientation; and, racemo (r) where the orientation is opposite. Propylenes with randomly arrayed pendant methyl groups—meaning those that do not have array with high levels of meso or racemic diads—are described as atactic. The low level of order exhibited of the side methyl groups preclude efficient packing in the solid state making atactic polypropylenes low melting, and generally soluble. In a syndiotactic polypropylene, the adjacent chiral centers have opposite orientation (0% m, 100% r) while isotactic polymers have adjacent centers with the same orientation (100% m, 0% r). The more ordered nature observed in the these polymers makes them capable of packing efficiently in the solid state to generate densely packed, more crystalline materials that display higher melting points and poorer solubility. These classifications represent limiting cases, however; in reality, some “stereoerrors” will be seen in syndio- and isotactic polypropylenes, and, depending on the dominate structure, these will be described by the % tacticty with the level of meso:racemo carbons being determined analytically.

The tacticity of each block is defined herein in terms of each block's isotactic index, determined using C-13 nuclear magnetic resonance and defined by pentads as described in the literature (see Angew. Chem. Int. Ed. 2006, 45, 2400 and references therein). Tacticity describes the relative stereochemistry of adjacent chiral centers within a macromolecule. Isotactic index defines, on average, the number of amount carbon atoms of the pendant methyl-groups of the polypropylene that reside on the same side macromolecular backbone (“meso” carbon substituents). In the case of isotactic index measured by pentads which is used herein, it refers to the number of five-monomer sequences where the carbon atom of the pendant methyl groups all reside on the same side of the molecular chain relative to the total number of pendant methyl-groups on the polypropylene chain. As used herein, the “net isotactic index” of the stereoblock polypropylene is simply the weighted average of the isotactic indeces of the blocks that make up the stereoblock polypropylene. For example, if a stereoblock polypropylene is a diblock made of 25 mol % of a first block having an isotactic index of 60 and 75 mol % of a second block having an isotactic index of 30, then the net isotactic index is 37.5, which is the sum of 0.25*60 and 0.75*30. Typical stereoblock polypropylenes according to the present invention can be produced according to U.S. Pat. No. 8,513,366.

According to preferred embodiments of the invention, the stereoblock polypropylene has a net isotactic index of between about 10% and about 80%, preferably between 20% and about 65%, more preferably between 30% and about 55%, and most preferably between 32% and about 50%. According to preferred embodiments of the invention, the isotactic index of the first block is between about 52% and 75%, preferably between about 55% and about 72%, and most preferably between about 60% and about 70%, and the isotactic index of the second block is between about 12% and about 48%, preferably between about 15% and about 45%, and most preferably between about 20% and about 40%. According to preferred embodiments of the invention, the difference between the isotactic index of the first block and the isotactic index of the second block is at least about 15%, preferably at least about 20%, and most preferably at least about 25%.

According to an embodiment of the invention, the stereoblock polypropylene is a diblock polymer. According to another embodiment of the invention, the stereoblock polypropylene is a tri-block polymer and the third block has an isotactic index of between about 50% and 95%, like the first block. According to yet another embodiment of the invention, the stereoblock polypropylene is a diblock copolymer and the composition further comprises a stereo-triblock polypropylene comprising a first block having an isotactic index of between about 50% and about 95%, a second block having an isotactic index of between about 5% and 50%, and a third block having an isotactic index of between about 50% and about 95%, wherein the difference between the isotactic index of the first block and the isotactic index of the second block is at least about 10% and the difference between the isotactic index of the third block and the isotactic index of the second block is at least about 10%. According to another embodiment of the invention, the stereoblock polypropylene is a pentablock copolymer in the pattern of A-B-A-B-A, wherein A is the first block and B is the second block.

The molecular weight of the stereoblock polypropylene used in the invention may vary over a wide range, depending on the application, in a known way. Preferably, the stereoblock polypropylene has a weight average molecular weight of between about 4,000 and about 500,000 daltons, preferably between about 8,000 and about 400,000 daltons, more preferably between about 12,000 and about 300,000 daltons, more preferably between about 12,000 and about 275,000 daltons, and most preferably between about 16,000 and about 250,000 Daltons. Molecular weight data was determined by gel permeation chromatography. The sample were made at approximately 1.0 mg/mL in trichlorobenzene. Samples were prepared by heating at 145° C. for approximately 2 hours and were not filtered prior to injection. Testing was performed at 145° C. Molar mass values (Mn, Mw, Mz) were calculated relative to polystyrene standards and are averages of three injections that possess standard deviation of less than 5 percent.

The relative amounts of the first block and the second block of the stereoblock polypropylene may vary over a wide range, depending on the application, in a known way. Preferably, the first block comprises between about 10 mol % and about 50 mol %, preferably between about 18 mol % and about 40 mol %, and most preferably between about 20 mol % and about 35 mol % of the stereoblock polypropylene. Preferably, the second block comprises between about 50 mol % and about 90 mol %, preferably between about 60 mol % and about 82 mol %, and most preferably between about 65 mol % and about 80 mol % of the stereoblock polypropylene.

It has been found that adhesives according to embodiments of the invention provide a better shear performance at the same peel or tack (and vice versa). This can be demonstrated by comparing a curve of shear performance versus peel or tack performance of the present invention compared to a similar curve of a known adhesive. Stated another way, from data reported in the literature (Polym. Chem., 2011, 2, 2155), the melting point of mainly isotactic polypropylenes generated with single-site catalyst systems can be found based on the following equation:

Tm=1.85*[mmmm]ₙₑₜ−12° C.,

wherein [mmmm]net is the net isotactic index of the stereoblock polypropylene.

Adhesives according to embodiments of the present invention, however, have a melting point which is at least 5° C. higher, preferably 7° C. higher, and most preferably 10° C. higher than the melting point calculated from the above equation. According to embodiments of the invention, the stereoblock polypropylene used in the adhesive of the present invention has a melting point of at least 75° C., preferably at least about 80° C., more preferably at least about 85° C., and most preferably at least about 90° C. The melting point and glass transition temperature as described herein are measured using Differential Scanning calorimetry (DSC) according to ASTM E-794-01 except with one modification to the test in that a scanning temperature of 20° C. per minute instead of 10° C. per minute was used.

The viscosity of the adhesive of the present invention may vary over a wide range, depending on the application, in a known way. The viscosity of the adhesive material according to the present invention should be generally at a viscosity at the application temperature appropriate to be processed and applied to its substrate. An adhesive with relatively low viscosity at a low application temperature is needed to be processed through standard hot melt adhesive equipment and to achieve the desired pattern and consequently suitable bonding performance at the application temperature. According to preferred embodiments of the present invention, the viscosity of the composition is between about 1,000 cP and about 500,000 cP at 163° C., preferably between about 2,000 cP and about 250,000 cP at 163° C., more preferably between about 2,000 cP and about 125,000 cP at 163° C., and most preferably between about 2,000 cP and about 100,000 cP at 163° C. The viscosity of an adhesive composition as described herein is measured by ASTM D3236.

The softening point of the adhesive of the present invention may vary over a wide range, depending on the application, in a known way. According to preferred embodiments of the present invention, the Ring & Ball softening point of the adhesive composition is between about 50° C. and about 150° C., preferably between about 55° C. and about 140° C., more preferably between about 60° C. and about 135° C., and most preferably between about 65° C. and about 130° C. Ring & Ball softening points were determined herein with an automated Herzog unit according to the method set forth in ASTM E-28.

As mentioned above, the adhesive composition of the invention comprises the stereoblock polypropylene and at least one of a tackifying resin and a plasticizer. According to embodiments of the invention, the stereoblock polypropylene is present in an amount of between about 5% and about 90%, preferably between about 10% and about 70%, more preferably between about 15% and about 50%, and most preferably between about 15% and about 35%, by weigh; the tackifying resin is present in an amount of between about 0% and about 70%, preferably between about 30% and 70%, preferably between about 40% and 60%, and most preferably between about 45% and about 55%, by weight; and the plasticizer is present in an amount of between about 10% and about 50%, preferably between about 15% and about 40%, and most preferably between about 20% and about 35%.

Embodiments of the hot melt adhesive composition of the present invention also include a tackifying resin (also referred to herein as a “tackifier”). As defined in the present description, the tackifier can be a molecule or a macro-molecule and generally is a chemical compound or a fairly low molecular weight polymer, compared to common polymers, from a natural source or from a chemical process or combination thereof that in general enhances the adhesion of a final hot melt adhesive composition. Representative resins include the C₅/C₉ hydrocarbon resins, synthetic polyterpenes, rosin, rosin esters, natural terpenes, and the like. More particularly, the useful tackifying resins include any compatible resins or mixtures thereof such as (1) natural and modified rosins including gum rosin, wood rosin, tall oil rosin, distilled rosin, hydrogenated rosin, dimerized rosin, and polymerized rosin; (2) glycerol and pentaerythritol esters of natural and modified rosins, including the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin; (3) copolymers and terpolymers of natural terpenes, such as styrene/terpene and alpha methyl styrene/terpene; (4) polyterpene resins generally resulting from the polymerization of terpene hydrocarbons, such as the bicyclic monoterpene known as pinene, in the presence of Friedel-Crafts catalysts at moderately low temperatures; also included are the hydrogenated polyterpene resins; (5) phenolic modified terpene resins and hydrogenated derivatives thereof such, for example, as the resin product resulting from the condensation, in an acidic medium, of a bicyclic terpene and a phenol; (6) aliphatic petroleum hydrocarbon resins resulting from the polymerization of monomers consisting primarily of olefins and diolefins; also included are the hydrogenated aliphatic petroleum hydrocarbon resins; and (7) cyclic petroleum hydrocarbon resins and the hydrogenated derivatives thereof. Mixtures of two or more of the above described tackifying resins may be required for some formulations. Also included are the cyclic or acylic C5 resins and aromatic modified acyclic or cyclic resins.

In an embodiment of the invention, the tackifier is included and selected from the group consisting of aliphatic and cycloaliphatic hydrocarbon resins and their hydrogenated derivatives, hydrogenated aromatic hydrocarbon resins, aromatically modified aliphatic or cycloaliphatic resins and their hydrogenated derivatives, polyterpene and styrenated polyterpene resins and mixtures thereof. In another embodiment of the invention, the tackifier is selected from the group consisting of a C₅ aliphatic hydrocarbon resin, a hydrogenated C₅ resin, a hydrogenated C₉ resin, a hydrogenated DCPD resin and an aromatic-modified DCPD resin.

Embodiments of the hot melt adhesive composition of the present invention also include a plasticizer. Plasticizers may be used in the present invention to control the behavior of the adhesive during formulating, application, and end-use. The plasticizer component useful in the present invention may be selected from any of the mineral based oils, petroleum based oils, liquid resins, liquid elastomers, polybutene, polyisobutylene, phthalate and benzoate plasticizers, and epoxidized soya oil. Preferably, the plasticizer is selected from the group consisting of mineral oil and liquid polybutene, and even more preferably mineral oil with less than 30% aromatic carbon atoms. A plasticizer is broadly defined as a typically organic composition that can be added to the thermoplastic rubbers and other resins to improve extrudability, flexibility, workability and stretchability in the finished adhesive. Any material which flows at ambient or application temperatures and is compatible in the compositions of the present invention may be useful. Preferably, the plasticizer has low volatility at temperatures of greater than about 40° C. The most commonly used plasticizers are oils which are primarily hydrocarbon oils, low in aromatic content and are paraffinic or naphthenic in character. The oils are preferably low in volatility, transparent and have little color and negligible odor. This invention also may include olefin oligomers, low molecular weight polymers, synthetic hydrocarbon oils, vegetable oils and their derivatives and similar plasticizing oils. Solid plasticizers may also be useful to the present invention. Examples of such plasticizers include 1,4-cyclohexane dimethanol dibenzoate, glyceryl tribenzoate, pentaerythritol tetrabenzoate, and dicylcohexylphthalate. Preference is given to the petroleum based oils with suitable naphthenic minerals oils useful in this invention of the types herein described above are commercially available from Nynas, under the trade name Nyplast®. Suitable liquid plasticizers include polybutene such as Indopol series materials supplied by Ineos. As required, blends of plasticizers can also be employed to adjust end use performance and final properties.

According to embodiments of the present invention, the plasticizer is included and is selected from the group consisting of mineral oil, synthetic oils, low molecular weight polymers, and liquid polybutene.

The hot melt adhesive of the present invention may also include a stabilizer or an antioxidant in an amount of from about 0.1% to about 5% by weight. Preferably from about 0.1% to 2% of a stabilizer or antioxidant is incorporated into the composition. The stabilizers which are useful in the hot melt adhesive compositions of the present invention are incorporated to help protect the polymers noted above, and thereby the total adhesive system, from the effects of thermal and oxidative degradation which normally occur during the manufacture and application of the adhesive as well as in the ordinary exposure of the final product to the ambient environment. Among the applicable stabilizers are hindered phenols and multifunction phenols, such as sulfur and phosphorous-containing phenols. Antioxidants, such as hindered amine phenols, may be characterized as phenolic compounds that also contain bulky radicals in close proximity to the phenolic hydroxyl group thereof and are preferred. In particular, tertiary butyl groups generally are substituted onto the benzene ring in at least one of the ortho positions relative to the phenolic hydroxyl group. The presence of these sterically bulky substituted radicals in the vicinity of the hydroxyl group serves to retard its stretching frequency and correspondingly, its reactivity; this steric hindrance thus provides the phenolic compound with its stabilizing properties.

Polyolefin nucleating agents may also be also present in the invention. Nucleating agents suitable for this invention are generally of the sub class of nucleating agents known as clarifying agents that are commonly employed in polyolefin additive packages to promote rapid crystallization. Suitable materials include dibenzylidene sorbitol derivatives such as Millad 3988 and Millad NX8000 supplied by Milliken as well as Irgaclear D produced by BASF. Other suitable agents include aromatic amide systems such as NJ Star NU-100 provided by New Japan Chemical Company. If included, the nucleating agent is generally present in the adhesive compositions in amounts of about 0.05 to 5.0% by weight of the composition, preferably about 0.1 to 2.5% by weight are utilized, and most preferably about 0.2 to 1.0% by weight. Blends of two or more nucleating agent may also be used. For example, a blend of a nucleating agent and a second nucleating agent that is different than the first nucleating agent may also be employed. From about 0.05% to about 5% by weight of one or more additional nucleating agent may be blended together with the first nucleating agent if desired. The nucleating agent may be used directly as a powder, as a slurry in a portion of suitable plasticizing agent, or as a component in a masterbatch of suitable polymer masterbatch such as Milliken NX-10. Nucleation packages such as those described in US 2015/0299526 can also be included to tailor the set up rate and bonding properties of the hot-melt adhesive.

It should be understood that other optional additives may be incorporated into the adhesive composition of the present invention in order to modify particular physical properties. These may include, for example, such materials as ultraviolet light (UV) absorbers, waxes, surfactants, inert colorants, titanium dioxide, fluorescing agents and fillers. Typical fillers include talc, calcium carbonate, clay silica, mica, wollastonite, feldspar, aluminum silicate, alumina, hydrated alumina, glass microspheres, ceramic microspheres, thermoplastic microspheres, baryte and wood flour and may be included in an amount up to 60% by weight, and preferably between 1 and 50% by weight.

In an embodiment of the invention, the hot melt adhesive composition does not include a wax. In embodiments of the invention in which wax is included, waxes may be included in the amount up to 20% by weight, preferably between 0.1% and 18% by weight. The wax may be selected from the group consisting of petroleum waxes, low molecular weight polyethylene and polypropylene, synthetic waxes and polyolefin waxes and mixtures thereof. In preferred embodiments, the wax is a low molecular weight polyethylene having a number average molecular weight of about 400 to about 6,000 g/mol. According to embodiments of the present invention, the adhesive composition further comprises a wax. In embodiments, the wax is present in an amount of between about 0.1% and about 20% by weight.

According to embodiments of the present invention, the adhesive composition further comprises an auxiliary polymer. The auxiliary polymer may be selected from the group consisting of ethylene vinyl acetate, polyethylene, low density polyethylene, linear low density polyethylene, polybutene-1, polybutene-1/ethylene polymers, and a styrenic block copolymer.

In embodiments of the invention, the hot melt adhesive composition comprises, consists essentially of, or consists of, a stereoblock polypropylene comprising a first block having an isotactic index of between about 50% and about 95% and a second block having an isotactic index of between about 5% and 50%, wherein the difference between the isotactic index of the first block and the isotactic index of the second block is at least about 10% and at least one of a tackifying resin and a plasticizer or both of a tackifying resin and a plasticizer. In embodiments of the invention, the composition includes the stereoblock polypropylene comprising a first block having an isotactic index of between about 50% and about 95% and a second block having an isotactic index of between about 5% and 50%, wherein the difference between the isotactic index of the first block and the isotactic index of the second block is at least about 10% and no other polymer.

The hot melt adhesive composition of the present invention may be formulated using any technique known in the art. A representative example of the mixing procedure involves placing all the components in a jacketed mixing vessel equipped with a rotor, and thereafter raising the temperature of the mixture to a range from 120° C. to 230° C. to melt the contents. It should be understood that the precise temperature to be used in this step would depend on the melting points of the particular ingredients. The constituents are individually or in certain combinations introduced to the vessel under agitation and the mixing is allowed to continue until a consistent and uniform mixture is formed.

In an embodiment of the invention, the adhesive is made using a traditional overhead mixer at about 180° C. First, the plasticizer, tackifier, and any antioxidant(s) are heated to desired temperature under an inert blanket and stirring is started for homogeneity. Then, the stereoblock polypropylene is added. Mixing while applying heat is continued until the mix is homogenous and the polymer is melted. Other conventional methods may be used to make the hot melt adhesive of the present invention. For example, methods employing static mixing, single screw extrusion, twin screw extrusion, and kneading, may be used. The hot melt adhesive is then cooled to room temperature and formed into chubs with a protective skin formed thereon or into pellets for shipment and use.

The resulting hot melt adhesive may then be applied to substrates using a variety of coating techniques. Examples include hot melt slot die coating, hot melt wheel coating, hot melt roller coating, melt-blown coating as well as slot, spiral spray, and wrapping spray methods such as those used to affix elastic strands. Spray techniques are numerous and can be done with or without assistance of compressed air that would shape the adhesive spray pattern. The hot melt adhesive material is generally pumped molten through hoses to the final coating spot on the substrates. Any application temperature above the softening point of the adhesive formulation is suitable.

The hot melt adhesive composition of the present invention may be used in a number of applications such as, for example, in disposable nonwoven hygienic articles, paper converting, flexible packaging, wood working, carton and case sealing, labeling and other assembly applications. Particularly preferred applications include diaper and adult incontinent brief elastic attachment, disposable diaper and feminine sanitary napkin construction, diaper and napkin core stabilization, diaper backsheet lamination, industrial filter material conversion, surgical gown and surgical drape assembly. It has been found that the adhesive of the invention is particularly useful as a construction adhesive in hygiene articles, such as diapers. Construction adhesives are typically used to bond a non-woven layer to a polyethylene film. Pressure-sensitive applications. Tape and label, pad attachment, etc. As well as elastic and stretch where adhesive must serve functional purpose beyond just adhering substrates.

The adhesive of the present invention can also be used with any application where various substrate materials are involved. Examples include nonwoven materials and polymeric films. Any substrate material and any substrate form could be used in any combination possible with the adhesive serving to bond a single substrate folded over on itself or two or more substrates together. The substrates can be of multiple forms, for example fiber, film, thread, strip, ribbon, tape, coating, foil, sheet, and band. The substrate can be of any known composition for example polyolefin, polyacrylic, polyester, polyvinyl chloride, polystyrene, cellulosic like wood, cardboard or paper. The bulk substrate's mechanical behavior can be rigid, plastic, or elastomeric. The above lists are not limitative or all-inclusive, but are only provided as common examples.

In an embodiment of the invention, a method of making a laminate comprises the step of applying the hot melt adhesive composition of the invention in a molten state to a primary substrate. In this embodiment, the laminate may be a tape or label and consists of the primary substrate serving as the backing for the tape or face for the label and the adhesive. In other embodiment, the method for making the laminate further comprises mating a secondary substrate to the primary substrate by contacting the secondary substrate with the adhesive composition before the adhesive is fully cooled. Upon allowing the adhesive to cool, the adhesive bonds the primary substrate to the secondary substrate. In embodiments in which the adhesive is suitable for use as a construction adhesive, the primary substrate may be a polyolefin film, such as polyethylene, and the secondary substrate may be a nonwoven material or layer.

In alternative embodiments of the invention, the adhesive is applied to the first substrate using a direct contact method of hot melt application, such as a slot or V-slot applicator head. Alternatively, the adhesive may be applied to the first substrate using a non-contact method of hot melt, such as a spray applicator.

The adhesive of the present invention can also be used with any application where various substrate materials are involved (along with the elastic strand). Examples include nonwoven materials and polymeric films. Any substrate material and any substrate form could be used in any combination possible with the adhesive serving to bond a single substrate folded over on itself and the elastic strand or two or more substrates together sandwiching the elastic strand. The substrates can be of multiple forms, for example fiber, film, thread, strip, ribbon, tape, coating, foil, sheet, and band, along with the elastic strand. The substrate can be of any known composition for example polyolefin, polyacrylic, polyester, polyvinyl chloride, or polystyrene. The above lists are not limitative or all-inclusive, but are only provided as common examples.

According to embodiments of the invention, a hot melt adhesive composition comprises: a stereoblock polypropylene comprising a first block having an isotactic index of between about 50% and about 95% and a second block having an isotactic index of between about 5% and 50%, wherein the difference between the isotactic index of the first block and the isotactic index of the second block is at least about 10%; and at least one of a tackifying resin or a plasticizer, wherein the stereoblock polypropylene and the at least one of the tackifying resin and the plasticizer are present in amounts effective to provide a hot melt adhesive composition which has: (1) a peel strength at 90° of at least 0.5 pound-force after aging at 25° C. when applied at 5 gsm add-on between a first polyethylene layer and a second polyethylene layer; (2) an initial loop tack of at least 1 pounds-force and an aged loop tack of at least 1 pounds-force when a polyethylene looped thread is applied to stainless steel at an adhesive thickness of 3 mils using an Instron 5500R tensile test frame equipped with a 100 Newton load cell with a speed of 12 inches per minute; and (3) a shear value of at least 500 minutes at 23° C. when applied between polished stainless steel and polyethylene terephthalate using a 1 kilogram weight.

### Aspects of the Invention

Aspect 1. A hot melt adhesive composition comprising:
   (a) a stereoblock polypropylene comprising a first block having an isotactic index of between about 50% and about 95% and a second block having an isotactic index of between about 5% and 50%, wherein the difference between the isotactic index of the first block and the isotactic index of the second block is at least about 10%;
   (b) at least one of a tackifying resin or a plasticizer.
Aspect 2. The composition of Aspect 1, wherein the stereoblock polypropylene has a net isotactic index of between about 10% and about 80%, preferably between 20% and about 65%, more preferably between 30% and about 55%, and most preferably between 32% and about 50%.
Aspect 3. The composition of Aspects 1 or 2, wherein the stereoblock polypropylene has a weight average molecular weight of between about 4,000 and about 500,000 daltons, preferably between about 8,000 and about 400,000 daltons, more preferably between about 12,000 and about 300,000 daltons, more preferably between about 12,000 and about 275,000 daltons, and most preferably between about 16,000 and about 250,000 daltons.
Aspect 4. The composition of any of Aspects 1-3, wherein:
   the isotactic index of the first block is between about 52% and 75%, preferably between about 55% and about 72%, and most preferably between about 60% and about 70%,
   the isotactic index of the second block is between about 12% and about 48%, preferably between about 15% and about 45%, and most preferably between about 20% and about 40%.
Aspect 5. The composition of any of Aspects 1-4, wherein the difference between the isotactic index of the first block and the isotactic index of the second block is at least about 15%, preferably at least about 20%, and most preferably at least about 25%.
Aspect 6. The composition of any of Aspects 1-5, wherein the stereoblock polypropylene is a diblock polymer.
Aspect 7. The composition of any of Aspects 1-5, wherein the stereoblock polypropylene is a tri-block polymer and the third block has an isotactic index of between about 50% and 95%.
Aspect 8. The composition of any of Aspects 1-5, wherein the stereoblock polypropylene is a diblock copolymer and the composition further comprises a stereo-triblock polypropylene comprising a first block having an isotactic index of between about 50% and about 95%, a second block having an isotactic index of between about 5% and 50%, and a third block having an isotactic index of between about 50% and about 95%, wherein the difference between the isotactic index of the first block and the isotactic index of the second block is at least about 10% and the difference between the isotactic index of the third block and the isotactic index of the second block is at least about 10%.
Aspect 9. The composition of any of Aspects 1-8, wherein the first block comprises between about 10 mol % and about 50 mol %, preferably between about 18 mol % and about 40 mol %, and most preferably between about 20 mol % and about 35 mol % of the stereoblock polypropylene; and
   the second block comprises between about 50 mol % and about 90 mol %, preferably between about 60 mol % and about 82 mol %, and most preferably between about 65 mol % and about 80 mol % of the stereoblock polypropylene.
Aspect 10. The composition of any of Aspects 1-9, wherein the stereoblock polypropylene has a melting point of at least 5° C. higher than the melting point calculated from the following equation:

Tm=1.85*[mmmm]net−12° C.,
wherein [mmmm]net is the net isotactic index of the stereoblock polypropylene; and
   the stereoblock polypropylene has a melting point of at least 75° C., preferably at least about 80° C., more preferably at least about 85° C., and most preferably at least about 90° C., as measured by DSC.
Aspect 11. The composition of any of Aspects 1-10, wherein the viscosity of the composition is between about 1,000 cP and about 500,000 cP at 163° C., preferably between about 2,000 cP and about 250,000 cP at 163° C., more preferably between about 2,000 cP and about 125,000 cP at 163° C., and most preferably between about 2,000 cP and about 100,000 cP at 163° C.
Aspect 12. The composition of any of Aspects 1-11 having a Ring & Ball softening point of between about 50° C. and about 150° C., preferably between about 55° C. and about 140° C., more preferably between about 60° C. and about 135° C., and most preferably between about 65° C. and about 130° C.
Aspect 13. The composition of any of Aspects 1-12, wherein:
   the stereoblock polypropylene is present in an amount of between about 5% and about 90%, preferably between about 10% and about 70%, more preferably between about 15% and about 50%, and most preferably between about 15% and about 35%, by weigh;
   the tackifying resin is present in an amount of between about 0% and about 70%, preferably between about 30% and 70%, preferably between about 40% and 60%, and most preferably between about 45% and about 55%, by weight; and
   the plasticizer is present in an amount of between about 10% and about 50%, preferably between about 15% and about 40%, and most preferably between about 20% and about 35%.
Aspect 14. The composition of any of Aspects 1-13, wherein the tackifying resin is selected from the group consisting of aliphatic and cycloaliphatic hydrocarbon resins and their hydrogenated derivatives, hydrogenated aromatic hydrocarbon resins, aromatically modified aliphatic or cycloaliphatic resins and their hydrogenated derivatives, polyterpene and styrenated polyterpene resins and mixtures thereof.
Aspect 15. The composition of any of Aspects 1-14, wherein the plasticizer is selected from the group consisting of mineral oil, synthetic oils, low molecular weight polymers, and liquid polybutene.
Aspect 16. The composition of any of Aspects 1-15 further comprising a stabilizer or antioxidant.
Aspect 17. The composition of any of Aspects 1-16 further comprising a wax.
Aspect 18. The composition of Aspect 17, wherein the wax is present in the amount between about 0.1% and about 20% by weight.
Aspect 19. The composition of any of Aspects 1-18 further comprising an auxiliary polymer selected from the group consisting of ethylene vinyl acetate, polyethylene, low density polyethylene, linear low density polyethylene, polybutene-1, polybutene-1/ethylene polymers and a styrenic block copolymer.
Aspect 20. The composition of any of Aspects 1-5 or 9-19, wherein the stereoblock polypropylene is a pentablock copolymer in the pattern of A-B-A-B-A, wherein A is the first block and B is the second block.
Aspect 21. A method of making a laminate comprising the step of applying the hot melt adhesive composition of any of Aspects 1 to 20 in a molten state to a primary substrate.
Aspect 22. The method of Aspect 21, wherein the laminate is a tape or label.
Aspect 23. The method of Aspect 21 further comprising mating a secondary substrate to the first substrate by contacting the secondary substrate with the adhesive composition.
Aspect 24. The method of any of Aspects 21-23, wherein the primary substrate is a polyethylene film.
Aspect 25. The method of Aspects 23 or 24, wherein the secondary substrate is a non-woven layer.
Aspect 26. A laminate made by the methods of any of Aspects 21-25.
Aspect 27. The composition of any of Aspects 1-20, wherein the stereoblock polypropylene and the at least one of the tackifying resin and the plasticizer are present in amounts effective to provide a hot melt adhesive composition which has: (1) a peel strength at 90° of at least 0.5 pound-force after aging at 25° C. when applied at 5 gsm add-on between a first polyethylene layer and a second polyethylene layer; (2) an initial loop tack of at least 1 pounds-force and an aged loop tack of at least 1 pounds-force when a polyethylene looped thread is applied to stainless steel at an adhesive thickness of 3 mils using an Instron 5500R tensile test frame equipped with a 100 Newton load cell with a speed of 12 inches per minute; and (3) a shear value of at least 500 minutes at 23° C. when applied between polished stainless steel and polyethylene terephthalate using a 1 kilogram weight.

### EXAMPLES

The following examples demonstrate several aspects of certain preferred embodiments of the present invention, and are not to be construed as limitations thereof.

In the examples below, polymers produced according to the general methods described in U.S. Pat. No. 8,513,366 were used in Table 1. Two inventive stereoblock propylene polymers were used in this study. In the materials described below, isotactic index (II) described is that determined by the concentration of mmmm pentads using Carbon-13 NMR. The first inventive stereoblock polymer (SBP1) possesses a di-block structure with 27 wt % of a polypropylene with an isotactic index of 65% and 73 wt % of propylene with a 35% isotactic index. SBP1 possesses a net isotactic index of 43%; if the stereoerrors in this sample were randomly arranged throughout the polymer chain, the predicted melting point, Tm, would be approximately 67° C. The measured by differential scanning calorimetry (DSC) for Tm for SBP1 is 97° C. which highlights one significant property shift offered by the inventive stereoblock polypropylenes. The second inventive stereoblock polymer, SBP2, is a tri-block consisting of a 12 wt % polypropylene end-block with a isotactic index of 65%, a 72 wt % of a polypropylene mid-block with an isotactic index of 31%, and, 16 wt % of a second polypropylene end block with a isotactic index of 61%. The melting point predicted for SBP2 which has a net isotactic index of 40% would be approximately 62° C. The Tm as measured by DSC for SBP2 is 94° C. Performance of adhesive made using the inventive materials were compared to commercial random stereoblock polypropylenes produced by Idemitsu and sold under the tradenames L-MODU S600 and S901. The isotactic index for the L-MODU polymers as determined by pentad 13-C NMR analysis is 52%; the DSC-determined Tm was found to be 76° C. which, unlike the inventive polymers, agrees well with the predicted value of 84° C. Physical property data, including the polydispersity index (PDI), which is Mw/Mn, for the inventive and comparative polymers used in this work are summarized in Table 1.

TABLE 1
Features and Physical Properties of Inventive Stereoblock
Polypropylenes and Random Stereoerror Polypropylenes

| | | | L-MODU | L-MODU |
|---|---|---|---|---|
| Polymer | SBP1 | SBP2 | S600 | S901 |
| Structure type | diblock | triblock | random | random |
| Block 1, wt % | 27 | 12 | 100 | 100 |
| Block 1, Isotactic Index, % | 65 | 67 | 52 | 52 |
| Block 2, wt % | 73 | 72 | — | — |
| Block 2 Isotactic Index, % | 35 | 31 | — | — |
| Block 3, wt % | 0 | 16 | — | — |
| Block 3 Isotactic Index, % | 0 | 61 | — | — |
| Net Isotactic Index, % | 43 | 40 | 52 | 52 |
| Mn, KDa | 165 | 107 | 46 | 65 |
| Mw, KDa | 233 | 243 | 115 | 185 |
| Mz, KDa | 293 | 331 | 202 | 342 |
| PDI (Mw/Mn) | 1.4 | 2.3 | 2.5 | 2.8 |
| Tg, ° C. | −7.8 | −7.4 | −8.1 | −8.0 |
| Tm, ° C. | 96.9 | 93.5 | 76.4 | 76.9 |

Adhesive Formulation

Adhesives were made from the inventive and comparative polymers listed in Table 1 using the formula shown in Table 2. The oil and tackifier along with the antioxidant package were added to a ca. 300 mL stainless steel reaction vessel under nitrogen purge. The materials were next mixed at 200 rpm using an overhead stirrer equipped with a pitched impeller and heated to 170° C. After reaching temperature and fully homogenizing the oil and tackifier, the polymer was slowly added at a rate such that the temperature did not drop below 150° C. After all the polymer had been added, the mixture was allowed to stir an additional 30 to 60 minutes at 177° C. to ensure full incorporation. The amount of polymer used was approximately 20 wt % for the formulations generated. The sample that contained the Idemitsu L-Modu S600 polymer was determined to have low viscosity at the 20% polymer level; therefore, the polymer content was increased to 34% at the expense of oil to eliminate performance shifts due to large viscosity differences between the materials.

TABLE 2
Adhesive Formulations

| Material | Ex 1 | Ex 2 | CE1 | CE2 |
|---|---|---|---|---|
| Nyflex 222B Oil, wt % | 29.71 | 29.71 | 29.71 | 29.71 |
| Escorez 5400, wt % | 49.51 | 49.51 | 49.51 | 49.51 |
| SBP1 | 19.80 | — | — | — |
| SBP2 | — | 19.80 | — | — |
| L-MODU S600 | — | — | 33.80 | |
| L-MODU S901 | — | — | — | 19.80 |
| Irgafos 168 | 0.65 | 0.65 | 0.65 | 0.65 |
| Irganox 1010 | 0.33 | 0.33 | 0.33 | 0.33 |

The constituents used are listed in Table 2. Nyflex 222B is a hydrotreated napthenic process oil available from Nynas Corporation. Escorez 5400 is a commercially-available dicyclopentadiene tackifying resin commercially available from ExxonMobil Chemical. Irgafos 168 is a tris(2,4-di-tert-butylphenyl) phosphate stabilizer and is available from many different suppliers. Irganox 1010 is a pentaerythritol tetrakis(3-(3,5-di-tert-butyl-4-hydroxyphenyl)propionate) stabilizer available from many different supplier.

Once all the samples were melted and homogeneous, the melted adhesive was poured into molds to provide samples for viscosity and ring and ball testing. The specimens were trimmed and allowed to condition at 50±5% relative humidity and 23±2° C. a minimum of 48 hours prior to testing.

Viscosity measurements were performed on a CAP 2000+ viscometer equipped with a #10 spindle. Spindle speed was varied to produce results between 10 and 90% of the full scale reading. Softening points were determined for the adhesives using a Herzog HRB 754. Physical test data is provided Table 3. As shown, all the samples possess similar viscosity values as a function of temperature. Despite the lower overall net tacticity, the samples made with the inventive di- and tri-stereoblock polypropylenes (Formulations Ex 1 and Ex 2, respectively) provided the higher thermal resistance as gauged by ring and ball softening point (RSBP).

TABLE 3
Physical Properties of Adhesives

| Sample | Ex1 | Ex 2 | CE1 | CE2 |
|---|---|---|---|---|
| CAP Viscosity at T = 121° C., cP | 26,750 | 30,650 | 29,050 | 29,450 |
| 135° C., cP | 14,200 | 16,250 | 14,675 | 15,475 |
| 148° C., cP | 8,900 | 10,150 | 8,850 | 10,100 |
| 163° C., cP | 5,600 | 6,300 | 5,300 | 6,400 |
| 177° C., cP | 3,800 | 4,275 | 3,500 | 4,400 |
| RBSP, ° C. | 86 | 82 | 78 | 73 |
| Shear Failure (1 mil), min,, Initial | 6,580 | 1,259 | 10,000+ | 3,169 |
| Shear Failure (1 mil), min, Aged | 7,955 | 7,346 | 10,000+ | 1,383 |
| Loop Tack lbs, 1 mil to SS, Initial | 3.9 | 2.8 | 0.0 | 1.3 |
| Loop Tack lbs, 1 mil to SS, Aged | 1.8 | 2.0 | 0.1 | 2.3 |
| Loop Tack, lbs, 3 mil to SS, Initial | 8.3 | 4.9 | 0.5 | 2.9 |
| Loop Tack, lbs, 3 mil to SS, Aged | 6.6 | 6.8 | 0.1 | 3.6 |
| Aged Loop Tack, lbs, 1 mil to PE | 0.7 | 1.6 | 0.0 | 0.4 |
| Aged Loop Tack, lbs, 1 mil to PP | 1.6 | 2.6 | 0.0 | 1.6 |
| 90° Peel (SS), pli | 1.8 | 3.4 | 0.2 | 1.5 |
| 180° Peel (SS), pli | 2.4 | 4.2 | 0.1 | 1.2 |
| 90° Peel (PE), pli | 1.8 | 1.3 | 0.0 | 0.7 |
| 180° Peel (PE), pli | 1.8 | 2.8 | 0.0 | 1.2 |
| 90° Peel (PP), pli | 2.7 | 1.8 | 0.0 | 1.0 |
| 180° Peel (PP), pli | 3.3 | 3.4 | 0.1 | 2.8 |
| SAFT (SS), ° C. | 62 | 61 | 76 | 53 |

Samples for bonding performance were prepared by slot coating the adhesives onto 2 mil (0.002 inch) polyethylene terephthalate (PET) films using a hot melt adhesive coater. A silicone coated release paper was placed over the adhesive film. Portions of the coated film were aged in an environmental chamber set at 65° C. and 80% relative humidity (RH). Both the initial (as made) and aged coated films were cut into 1×3 inch strips. The release paper was removed and the adhesive was bonded to polished stainless steel (SS) panels using a 2 kg hand roller. These shear specimens were allowed to age in condition at 50+/−5% relative humidity and 23+/−2° C. for a minimum of 48 hours prior to testing. The samples were then placed into shear fixtures at 23° C. and a 1 kg weight attached to the PET strip. The values listed in Table 3 for “shear failure” indicate the time, in minutes, until bond failure indicated by the weight falling.

As can be seen in Table 3, the adhesive made with formulation L-MODU S600 had the longest shear resistance—likely due to the higher polymer content in the formulation. Despite having a similar level of polymer loading and formulated viscosity to Comparative Example 2 (CE2) made with L-MODU S901, the Ex 1 diblock adhesive displayed inventive significantly higher initial shear performance. Most notably, both inventive adhesives (Ex 1 and Ex 2) displayed significantly improved aged shear resistance than the comparative example (CE2).

Loop tack testing was performed on the as-made and aged coated adhesive samples. For aging, the coated film samples were allowed to condition at 50+/−5% relative humidity and 23+/−2° C. for a minimum of 48 hours prior to testing. The samples were then cut into 1 inch by 5 inch strips. The strips were looped so that the adhesive was on the outside of the loop and the sample placed in an Instron 5500R tensile test frame equipped with a 100 N load cell using a speed of 12 inches/minute. The loop tack test was performed on clean stainless steel (SS) panels with a new loop used on a clean area of a separate panel for each test. Two adhesive thicknesses on the PET film were tested, 1 mil and 3 mil. Both initial and aged samples of the inventive formulations (Ex 1 and Ex 2) performed similar to the Comparative Example 2 at 1 mil thickness. At 3 mils, however, the inventive examples (Ex 1 and Ex 3) displayed substantially higher loop tack values than CE2 initially and upon aging. Comparative Example 1, CE1, which contains a higher polymer loading and displayed high shear bonding performance, was found to give no measurable bonding to stainless steel in loop tack testing.

Further study of the tack performance of the aged adhesives was performed on polyethylene (PE) and polypropylene (PP) substrates. The results are listed below in Table 3. As shown, the inventive formulations generated with stereoblock polypropylenes (Ex 1 and Ex 2) displayed equivalent or improved loop tack performance relative to the comparative samples (CE1 and CE2).

Peel tests were performed using an Instron 5500R tensile test frame equipped with a 100 N load cell using a speed of 12 inches/minute. For these tests, aged adhesive previously coated at 1 mil thickness onto 2.0 mil PET film with a silicone liner top sheet was cut into 1 inch wide by 3 inch long strips and conditioned per previous testing. The liner was peeled back to expose approximately 1 inch of the adhesive. The exposed adhesive was placed on clean panels of various substrates and then the samples were rolled with a 2 kg roller to bond the adhesive to the panel. The panels were then placed in a jig and the peel values recorded for the 90° and the 180° peel as shown in Table 3. As shown the inventive formulations (Ex 1 and Ex 2) display higher peel bonding strengths relative to the comparative examples (CE1 and CE2) on stainless steel (SS), polyethylene (PE), and polypropylene (PP) substrates.

Shear adhesion failure temperature (SAFT) testing was performed on aged adhesive samples prepared in a similar manner to the shear testing panels. The conditioned panels were placed in a forced air oven that ramped the temperature of the panels from ambient to 200° F. at 4° F./min. A 1 kg weight was used in the testing. Failure times were recorded remotely and are shown in Table 3. Much like the results of room temperature shear testing, CE1 prepared at a higher polymer loading gave the highest SAFT value. The inventive formulations (CE1 and CE2), however, displayed high thermal shear bonding behavior relative to the comparative example (CE2) made at a similar polymer loading.

As shown in the results above, the inventive adhesives (Ex 1 and Ex 2) containing stereo-di- and tri-block polypropylenes offer substantial benefits compared to formulations generated from commercial random stereoerror analogues (CE1 and CE2). At similar viscosities, the inventive adhesives display vastly more-balanced shear and peel/tack performance makings them well-suited for a variety of applications including pressure sensitive adhesives. As shown in Table 3, the first comparative example (CE1) shows that adhesives can be generated that display high shear bonding performance using random stereoerror polypropylenes. This shear performance comes at the expense of pressure-sensitivity as shown by peel and loop tack displayed by CE1 in loop tack and peel tests to a variety of substrates. The second comparative example (CE2) displays moderately good tack and peel values to numerous substrates; nevertheless, this is accompanied by decreased shear bonding performance and lower overall thermal resistance. The inventive formulations break these intrinsic compromises and allow relatively low viscosity adhesives to be generated that display the tack required to be suitable for pressure-sensitive adhesive applications without leading to compromises shear performance and thermal resistance.

Where a range of values is provided, it is understood that each intervening value, and any combination or sub-combination of intervening values, between the upper and lower limit of that range and any other stated or intervening value in that stated range, is encompassed within the range of values recited. In addition, the invention includes a range of a constituent which is the lower limit of a first range and an upper limit of a second range of that constituent.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue or prior invention.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

1. A hot melt adhesive composition comprising:
(a) a stereoblock polypropylene comprising a first block having an isotactic index of between about 50% and about 95% and a second block having an isotactic index of between about 5% and 50%, wherein the difference between the isotactic index of the first block and the isotactic index of the second block is at least about 10%;
(b) at least one of a tackifying resin or a plasticizer.

2. The composition of claim 1, wherein the stereoblock polypropylene has a net isotactic index of between about 10% and about 80%.

3. The composition of claim 1, wherein the stereoblock polypropylene has a weight average molecular weight of between about 4,000 and about 500,000 daltons.

4. The composition of claim 1, wherein:
the isotactic index of the first block is between about 52% and 75%, and
the isotactic index of the second block is between about 12% and about 48%.

5. The composition of claim 1, the difference between the isotactic index of the first block and the isotactic index of the second block is at least about 15%.

6. The composition of claim 1, wherein the stereoblock polypropylene is a diblock polymer.

7. The composition of claim 1, wherein the stereoblock polypropylene is a tri-block polymer and the third block has an isotactic index of between about 50% and 95%.

8. The composition of claim 1, wherein the stereoblock polypropylene is a diblock copolymer and the composition further comprises a stereo-triblock polypropylene comprising a first block having an isotactic index of between about 50% and about 95%, a second block having an isotactic index of between about 5% and 50%, and a third block having an isotactic index of between about 50% and about 95%, wherein the difference between the isotactic index of the first block and the isotactic index of the second block is at least about 10% and the difference between the isotactic index of the third block and the isotactic index of the second block is at least about 10%.

9. The composition of claim 1, wherein:
the first block comprises between about 10 mol % and about 50 mol % of the stereoblock polypropylene; and
the second block comprises between about 50 mol % and about 90 mol % of the stereoblock polypropylene.

10. The composition of claim 1, wherein:
the stereoblock polypropylene has a melting point of at least 5° C. higher than the melting point calculated from the following equation:
Tm=1.85*[mmmm]net−12° C.,
wherein [mmmm]net is the net isotactic index of the stereoblock polypropylene; and
the stereoblock polypropylene has a melting point of at least 75° C. as measured by DSC.

11. (canceled)

12. The composition of claim 1 having a Ring & Ball softening point of between about 50° C. and about 150° C.

13. The composition of claim 1, wherein:
the stereoblock polypropylene is present in an amount of between about 5% and about 90% by weight;
the tackifying resin is present in an amount of between about 30% and 70% by weight; and
the plasticizer is present in an amount of between about 10% and about 50% by weight.

14. (canceled)

15. (canceled)

16. (canceled)

17. (canceled)

18. (canceled)

19. (canceled)

20. The composition of claim 1, wherein the stereoblock polypropylene is a pentablock copolymer in the pattern of A-B-A-B-A, wherein A is the first block and B is the second block.

21. A method of making a laminate comprising the step of applying the hot melt adhesive composition of claim 1 in a molten state to a primary substrate.

22. The method of claim 21, wherein the laminate is a tape or label.

23. The method of claim 21 further comprising mating a secondary substrate to the first substrate by contacting the secondary substrate with the adhesive composition.

24. The method of claim 23, where the primary substrate is a polyethylene film.

25. The method of claim 24, wherein the secondary substrate is a non-woven layer.

26. A laminate made by the method of claim 21.

27. A hot melt adhesive composition comprising:
(a) a stereoblock polypropylene comprising a first block having an isotactic index of between about 50% and about 95% and a second block having an isotactic index of between about 5% and 50%, wherein the difference between the isotactic index of the first block and the isotactic index of the second block is at least about 10%; and
(b) at least one of a tackifying resin or a plasticizer,
wherein the stereoblock polypropylene and the at least one of the tackifying resin and the plasticizer are present in amounts effective to provide a hot melt adhesive composition which has: (1) a peel strength at 90° of at least 0.5 pound-force after aging at 25° C. when applied at 5 gsm add-on between a first polyethylene layer and a second polyethylene layer; (2) an initial loop tack of at least 1 pounds-force and an aged loop tack of at least 1 pounds-force when a polyethylene looped thread is applied to stainless steel at an adhesive thickness of 3 mils using an Instron 5500R tensile test frame equipped with a 100 Newton load cell with a speed of 12 inches per minute; and (3) a shear value of at least 500 minutes at 23° C. when applied between polished stainless steel and polyethylene terephthalate using a 1 kilogram weight.
